(19) United States
(12) Patent Application Publication
(10) Pub. No.: US 2008/0226259 A1
(43) Pub. Date: Sep. 18, 2008

(54) Recording apparatus, control method, and program

(75) Inventor: Kazushi Umetsu, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/070,721

(22) Filed: Feb. 20, 2008

(30) Foreign Application Priority Data
Feb. 21, 2007 (JP) P2007-040348

(51) Int. Cl. H04N 5/76

(52) U.S. Cl. 386/94; 386/E05.07

(57) ABSTRACT

In the present invention, there is provided a recording apparatus for recording content to a content recording medium, which may include dubbing means for recording content recorded to the content recording medium to another content recording medium for dubbing; determining means for determining whether content recorded to the content recording medium satisfies a predetermined condition; and controlling means for recording, if content with copy control information thereof set to no-more-copies indicative of copy prohibition is found not satisfying the predetermined condition, the content from the content recording medium to the another content recording medium and then deleting the content from the content recording medium and, if the content with the copy control information thereof set to no-more-copies is found satisfying the predetermined condition, recording the content from the content recording medium to the another content recording medium and leaving the content on the content recording medium.

### CROSS-REFERENCE TO RELATED APPLICATIONS

This application claims priority from Japanese Patent Application No. JP 2007-040348 filed in the Japanese Patent Office on Feb. 21, 2007, the entire content of which is incorporated herein by reference.

### BACKGROUND OF THE INVENTION

1. Field of the Invention

The present invention relates to a recording apparatus, a control method, and a program and, more particularly, to a recording apparatus, a control method, and a program that are configured to provide the flexible dubbing of content, such as digital broadcasts, for example.

2. Description of the Related Art

Analog terrestrial broadcasting services are scheduled to be replaced by digital terrestrial broadcasting in 2011. Therefore, the transition from analog to digital is currently carried out.

Now, referring to FIG. 1, there is shown an exemplary configuration of a broadcasting system for transmitting and receiving digital broadcasting services, such as digital terrestrial broadcasting, BS (Broadcasting Satellite) digital broadcasting, and CS (Communication Satellite) digital broadcasting.

In FIG. 1, the broadcasting system is made up of a transmission apparatus 101, a recording apparatus 102, and a monitor 103.

The transmission apparatus 101 broadcasts (or transmits) content data including AV (Audio Visual) data of images, such as moving images accompanied by voice, and audio data, as programs by digital broadcasting.

The recording apparatus 102 is an apparatus configured to record video that also functions as a receiving apparatus for receiving digital broadcasting, namely, a HD (Hard Disk) recorder, for example. The recording apparatus 102 receives digital broadcast RF (Radio Frequency) signals from the transmission apparatus 101 and supplies content that is a broadcast program included in the received signal to the monitor 103 or record the content in the recording apparatus 102.

Therefore, the recording apparatus 102 is made up of a digital tuner 111, a HD 112, and an output interface 113, for example.

The digital tuner 111 receives a digital broadcast RF signal from the transmission apparatus 101 and executes demodulation and other necessary processing on the received RF signal, thereby obtaining content included in the RF signal as a program.

The HD 112 records, as required, the content obtained through the digital tuner 111. The content recorded to the HD 112 is reproduced as required to be supplied to the output interface 113 or a removable medium 114 which will be described later.

The output interface 113 outputs content supplied from the digital tuner 111 and content supplied from the HD 112 externally. In FIG. 1, the output interface 113 supplies content received from the digital tuner 111 and content received from HD 112 to the monitor 103.

The monitor 103, made up of a CRT (Cathode Ray Tube) or an LCD (Liquid Crystal Display) for example, displays an image as the content supplied from the output interface 113 and outputs a voice from a loudspeaker, not shown.

In the broadcasting system configured as described above, an RF signal from the transmission apparatus 101 is received at the digital tuner 111 of the recording apparatus 102 and the content contained in the received RF signal is supplied to the monitor 103 through the output interface 113 to be displayed and/or sounded.

Further, in the recording apparatus 102, the content contained in the RF signal received at the digital tuner 111 is recorded to the HD 112 as required.

On the recording apparatus 102, a removable medium 114, such as an optical disk including Blu-ray Disc and DVD (Digital Versatile Disc) and a memory card including Memory Stick (a trademark of Sony Corporation) is removably loaded. The recording apparatus 102 can write, as required, the content recorded to the HD 112 to the removable medium 114 loaded on the recording apparatus 102.

Referring to FIG. 2, there is shown a more detailed exemplary configuration of the recording apparatus 102 shown in FIG. 1.

It should be noted that, with reference to FIG. 2, similar components previously described with reference to FIG. 1 are denoted by the same reference numerals and the description thereof will be appropriately skipped.

The digital tuner 111 receives an RF signal of digital broadcasting and executes demodulation and other processing on the received RF signal to obtain an MPEG-TS (Moving Picture Experts Group Transport Stream) called a full TS, supplying the obtained transport stream to a descrambler 121.

The descrambler 121 descrambles the scrambled full transport stream received from the digital tuner 111 and supplies the descrambled full transport stream to a PID (Packet Identification) filter 122.

Of the TS (Transport Stream) packets making up the full TS supplied from the descrambler 121, the PID filter 122 extracts a TS packet having a predetermined value of PID, namely, a TS packet in which AV data of particular content and control data are contained, and supplies the extracted TS packet to a PRI (Packet Replace Inserter) 123 and a demultiplexer 124.

It should be noted that, in FIG. 2, the PID filter 122 is arranged immediately after the descrambler 121; however, it is also practicable to arrange the PID filter 122 immediately before the descrambler 121 (that is, between the digital tuner 111 and the descrambler 121).

The demultiplexer 124 separates the TS packet of full TS supplied from the PID filter 122 into TS packets of image, audio, and control data. Next, the demultiplexer 124 supplies the AV data of image and audio of the content to an AV (Audio Visual) decoder 126 and the control data to a PSI/SI (Program Specific Information/Service Information) controller 125.

The PSI/SI controller 125 analyzes the control data received from the demultiplexer 124 to configure PSI/SI.

PSI/SI includes PMT (Program Map Table) including PID of a TS packet of image or audio, NIT (Network Information Table) including channel number and so on, BIT (Broadcaster Information Table) including broadcasting station (broadcaster) identification information to identify a broadcasting station, and SDT (Service Description Table) including channel name and so on. The PSI/SI controller 125 extracts necessary information from PSI/SI and supplies the extracted information to the PRI 123 and an HD recording control unit 130.

The PMT of PSI/SI also includes a digital copy control descriptor as CCI (Copy Control Information) for controlling content copy. On the basis of this digital copy control descriptor, the PSI/SI controller 125 recognizes the CCI of content.

Further, the PSI/SI controller 125 obtains, from the CCI of content, the CCI of use in recording or outputting of this content and supplies the obtained CCI to the output interface 113, PRI 123, a multiplexer 129, and the HD recording control unit 130.

Typical CCI includes copy-free, copy-once, no-more-copies, and copy-never.

Copy-free denotes the permission of copy without any condition. Copy-once denotes the permission of copy only once. No-more-copies and copy-never denote that copy is prohibited.

It should be noted that no-more-copies is the CCI of the copied content with CCI set to copy-once, while copy-never is the CCI of the content of which copy is prohibited from the beginning.

If the CCI of content is copy-once, for example, the PSI/SI controller 125 obtains no-more-copies as the CCI for use in recording or outputting this content, namely, changes the CCI of the content from copy-once to no-more-copies, supplying the resultant CCI to the output interface 113, the PRI 123, the multiplexer 129, and the HD recording control unit 130.

Namely, if the CCI of content is copy-once, for example, the PSI/SI controller 125 instructs the output interface 113, the PRI 123, the multiplexer 129, and the HD recording control unit 130 to change the CCI for use in recording or outputting this content to no-more-copies.

On the other hand, the AV decoder 126 decodes the content data supplied from the demultiplexer 124. Namely, the content data supplied from the demultiplexer 124 is encoded by the MPEG standard, so that the AV decoder 126 decodes the content data encoded by the MPEG standard.

Next, the AV decoder 126 supplies the content data (AV data) of a baseband obtained as the result of the decoding to AV encoders 127 and 128.

The AV encoder 127 encodes the content data supplied from the AV decoder 126 into the data having a format corresponding to a device (the monitor 103 shown in FIG. 1 for example) connected to the output interface 113 and supplies the encoded content data to the output interface 113.

In accordance with the CCI received from the PSI/SI controller 125, the output interface 113 generates, from the content data received from the AV encoder 127, a signal provided with a copy protection of a predetermined scheme and outputs the generated, copy-protected signal.

It should be noted that the output interface 113 can output content as either an analog signal or a digital signal.

Analog signals to be outputted from the output interface 113 include a composite signal and a component signal, for example. The content based on analog signal can be copy-protected by CGMS-A (Copy Generation Management System-Analog), for example.

Digital signals to be outputted from the output interface 113 include signals compliant with such standards as HDMI (High Definition Multimedia Interface), DLNA (Digital Living Network Alliance), i.link (IEEE (Institute of Electrical and Electronics Engineers) 1394), and S/PDIF (Sony Philips Digital Interface), for example.

With HDMI, HDCP (High-bandwidth Digital Content Protection) is used as a copy protection scheme; with DLNA and i.link, DTCP (Digital Transmission Content Protection) is used as a copy protection scheme. It should be noted that, with HDCP and DTCP, the outputting of content data to a device connected to the output interface 113 therefrom needs to satisfy the condition of a successful authentication between the output interface 113 and the device connected thereto.

The recording apparatus 102 shown in FIG. 2 can record content that is a digital broadcast program. The recording apparatus 102 has two content recording modes; a DR (Direct Recording) mode and a re-encode mode.

In the DR mode, a digital broadcast signal is recorded almost without change, so that content is recorded with the picture quality and sound quality provided by digital broadcasting.

On the other hand, in the re-encode mode, a digital broadcast signal is decoded and then re-encoded to be recorded.

If the recording apparatus 102 is in the DR mode in recording a particular item of content that is a digital broadcast program, an output of the PID filter 122 is recorded to the HD 112 via the PRI 123 and the HD recording control unit 130 to be described later.

Namely, in the DR mode, in order to record the content data of a service (or a channel) subject to recording to the HD 112, a partial TS is created (or reconfigured), in the PRI 123, from a full TS supplied from the PID filter 122 and the created partial TS is outputted to the HD recording control unit 130.

It should be noted that, in the creation of a partial TS in the PRI 123, some items of the control data of full TS content is manipulated in replacement, addition, or deletion, for example, but few AV data are manipulated.

In the PRI 123, the manipulation of the control data is executed under the control of the PSI/SI controller 125. Namely, as described above, for example, if the CCI of content is set to copy-once, then the PSI/SI controller 125 controls the PRI 123 and the HD recording control unit 130 so as to change the CCI of that content from copy-once to no-more-copies.

Under the control of the PSI/SI controller 125, the PRI 123 changes the digital copy descriptor as the CCI in the PMT contained in the control data in the full TS received from the PID filter 122 from copy-once to no-more-copies or adds a new descriptor as the CCI of no-more-copies into the control data.

It should be noted that the above-mentioned manipulation of control data needs the detection of a digital copy descriptor as the CCI of PMT contained in control data or the position of the control data to which a new description is added, thereby necessary a reasonable time.

As described above, in the DR mode, each partial TS is transmitted from the PRI 123 to the HD recording control unit 130 and a command of the CCI of content contained in that partial TS is supplied from the PSI/SI controller 125 to the HD recording control unit 130.

The HD recording control unit 130 is made up of a HDD title database management block 131, a HDD file system 132, a buffer manager 133, and an ATA (Advanced Technology Attachment) controller 134 and controls the recording and reproduction of data to and from the HD 112.

Namely, in the HD recording control unit 130, the HDD title database management block 131 generates a title database for managing the content stored in the HD 112.

The title database contains titles of content to be displayed on a title list when the title list is displayed as a list of the content recorded to the HD 112, the information about channels on which content has been broadcast, and the information (hereafter appropriately referred to as broadcasting form identification information) indicative of in which of broadcasting forms, terrestrial digital, BS digital, and CS digital, particular content has been broadcast.

The HDD title database management block 131 generates a title database by use of the information extracted from the PSI/SI supplied from the PSI/SI controller 125 to the HD recording control unit 130.

In accordance with a command of the CCI of the content to be recorded from the PSI/SI controller 125 to the HD 112, the HDD title database management block 131 registers the CCI (or the indicative thereof) of the content to the title database. Therefore, the title database also contains CCIs.

It should be noted that the title database generated by the HDD title database management block 131 is supplied to a HDD 135 via the HDD file system 132, the buffer manager 133, and the ATA controller 134 to be recorded to the HD 112 of the HDD 135. Alternatively, the title database is supplied to a nonvolatile memory, such as an NVRAM (Nonvolatile Random Access Memory), not shown, to be stored therein.

The HDD file system 132 is configured to be supplied with content data and so on from the PRI 123 and the multiplexer 129 which is described later. The HDD file system 132 executes processing such that the content data and so on recorded to the HD 112 from the PRI 123 or the multiplexer 129 can be handled as a file and supplies the content data and so on thus processed to the buffer manager 133.

In addition, the HDD file system 132 supplies the content data and so on reproduced (or read) from the HD 112 and temporarily stored in the buffer manager 133 to a CODEC (Coder/Decoder) 137 to be described later, as required, or outputs the content data and so on from the output interface 113 via a route, not shown.

The buffer manager 133 temporarily stores the data supplied from the HDD file system 132 and supplies the data to the ATA controller 134. Also, the buffer manager 133 temporarily stores the data reproduced from the HD 112 to be supplied via the ATA controller 134 and supplies the stored data to the HDD file system 132.

In the buffer manager 133, temporarily storing data as described above allows the execution of recording and reproduction of data with the HD 112 apparently at the same time or, if the recording apparatus 102 has a digital tuner in addition to the digital tuner 111, temporarily storing data allows the recording the content as two programs to be outputted from the digital tuner 111 and the additional digital tuner to the HD 112 apparently at the same time.

The ATA controller 134 that is an interface of a HDD (Hard Disk Drive), controls the HDD 135 such that the data supplied from the buffer manager 133 is stored to the HD 112. Also, the ATA controller 134 controls the HDD 135 such that the data recorded to the HD 112 is reproduced, for example.

It should be noted that the ATA controller 134 has a capability of data encryption and decryption so as to protect content against so-called unauthorized copy. The data to be recorded to the HD 112 is encrypted by the ATA controller 134 before being supplied to the HDD 135. The data (encrypted) reproduced from the HD 112 in the HDD 135 is decrypted by the ATA controller 134 before being supplied to the buffer manager 133.

Copy protection methods configured to protect content against unauthorized copy at the time of content recording and transmission include CPRM (Content Protection for Prerecorded Media), CPS for BD-RE (Content Protection System for Blu-ray), and AACS (Advanced Access Content System).

In the HD recording control unit 130 configured as described above, if the recording mode is the DR mode, the HDD file system 132 supplies the partial TS received from the PRI 123 to the buffer manager 133.

The buffer manager 133 temporarily stores the data received from the HDD file system 132, namely, the partial TS in this case, and then supplies the partial TS to the ATA controller 134.

In the ATA controller 134, the partial TS as the data from the buffer manager 133 is encrypted to be supplied to the HDD 135.

In the HDD 135, the partial TS from the ATA controller 134 is stored in the HD 112.

In the HD recording control unit 130, the HDD title database management block 131 generates a title database for the content recorded to the HD 112 by the partial TS.

Namely, on the basis of the information and so on supplied from the PSI/SI controller 125 to the HD recording control unit 130, the HDD title database management block 131 generates a title database that contains the title of the content of the partial TS recorded to the HD 112, the channel information about the content, the broadcasting form identification information of the content, and the CCI (that follows a command issued from the PSI/SI controller 125) of the content.

The title database generated by the HDD title database management block 131 is supplied to the HDD 135 via the HDD file system 132, the buffer manager 133, and the ATA controller 134, for example, as described above, to be recorded to the HD 112.

If the recording mode is the DR mode, the output of the PID filter 122 is supplied to the HDD 135 via the PRI 123 and the HD recording control unit 130 as described above, thereby recording the content data (or the partial TS) to the HD 112. On the other hand, if the recording mode is re-encode mode, then the output of the PID filter 122 is recorded to the HD 112 via the demultiplexer 124, the AV decoder 126, the AV encoder 128, the multiplexer 129, and the HD recording control unit 130.

Namely, in the re-encode mode, the AV encoder 128 executes appropriate signal processing (image processing, audio processing, data manipulation and extraction processing, and so on) on the base-band content data supplied from the AV decoder 126, thereby encoding the content data into a predetermined format, the resultant content data being supplied to the multiplexer 129.

The multiplexer 129 multiplexes the content data having a predetermined format received from the AV encoder 128 with the CCI and so on issued from the PSI/SI controller 125 to get multiplexed data, such as an MPEG-PS (Program Stream) that can be recorded to a DVD and an AVC-HC (Advanced Video Codec High Definition), which are supplied to the HD recording control unit 130.

In the HD recording control unit 130, the multiplexed data received from the multiplexer 129 is recorded to the HD 112 in the same manner as the above-mentioned DR mode.

Namely, in the HD recording control unit 130, the HDD file system 132 supplies the multiplexed data received from the multiplexer 129 to the buffer manager 133.

The buffer manager 133 temporarily stores the data supplied from the HDD file system 132, namely, the multiplexed data in this case, and then supplies the stored multiplexed data to the ATA controller 134.

In the ATA controller 134, the multiplexed data supplied from the buffer manager 133 is encrypted to be supplied to the HDD 135.

In the HDD 135, the multiplexed data from the ATA controller 134 is recorded to the incorporated HD 112.

In the HD recording control unit 130, the HDD title database management block 131 generates a title database for the content recorded to the HD 112 in the form of multiplexed data.

Namely, on the basis of the information and so on supplied from the PSI/SI controller 125 to the HD recording control unit 130, the HDD title database management block 131 generates a title database that contains the title of the content made up of the multiplexed data recorded to the HD 112, the channel information of the content, and broadcasting form identification information of the content, and the CCI (that follows a command from the PSI/SI controller 125) of the content.

The title database generated by the HDD title database management block 131 is supplied to the HDD 135 via the HDD file system 132, the buffer manager 133, and the ATA controller 134 as described above for example to be recorded to the HD 112.

It should be noted that the recording mode of the recording apparatus 102 may be only one of the DR mode and the re-encode mode. When the recording apparatus 102 is in only the DR mode, the AV encoder 128 and the multiplexer 129 that are used only in the re-encode mode are no longer required. If the recording apparatus 102 is in only the re-encode mode, the PRI 123 that is used only in the DR mode is no longer required.

Next, the content recorded to the HD 112 incorporated in the recording apparatus 102 can be dubbed to a medium other than the HD 112.

To be more specific, the recording apparatus 102 has a drive 141 configured to drive the removable medium 114 removably loaded thereon and can dub the content recorded to the HD 112 to the removable medium 114 as required.

When dubbing the content recorded to the HD 112 to the removable medium 114, a dubbing control block 136 controls the HD recording control unit 130, a CODEC 137, a removable medium recording control unit 138 and so on to record the content recorded to the HD 112 to the removable medium 114 via the HD recording control unit 130, the CODEC 137, and the removable medium recording control unit 138.

To be more specific, the dubbing control block 136 controls the HD recording control unit 130 so as to reproduce the content data subject to dubbing from the HD 112.

It should be noted that the dubbing control block 136 is configured to control each of component blocks of the recording apparatus 102 as required, so that the dubbing control block 136 is connected to each component block to be controlled, the connection lines between the dubbing control block 136 and the component blocks being omitted for the convenience of illustration.

In the HD recording control unit 130, under the control of the dubbing control block 136, the content data subject to dubbing is reproduced from the HD 112 to be supplied to the CODEC 137 via the ATA controller 134, the buffer manager 133, and the HDD file system 132.

The CODEC 137 executes conversion processing, such as rate conversion and format conversion, on the content data supplied from the HD recording control unit 130 as required and supplies the processed content data to the removable medium recording control unit 138.

In dubbing content data from the HD 112 to the removable medium 114 for example, the content data is transmitted from the HD 112 to the removable medium 114 for example in either a fast transfer manner, such as a times-four transfer or a an re-encode transfer (low-speed transfer), such as a times-one transfer.

The high-speed transfer or the re-encode transfer of the content data subject to dubbing depends on whether the content data subject dubbing needs to be converted and on the complexity of the conversion processing, and on the time necessary for the conversion processing, for example.

For example, if the similarity between the format of content data subject to dubbing recorded to the HD 112 and the format of data recorded to the removable medium 114 is high and therefore no conversion processing is required or, if the conversion processing is required and the conversion processing is simple and takes only a short time, the content data subject to dubbing can be transferred from the HD 112 to the removable medium 114 at high speeds.

On the other hand, if the similarity between the format of content data subject to dubbing recorded to the HD 112 and the format of data recorded to the removable medium 114 is low and therefore it is necessary to execute complicated and time-consuming conversion processing, the content data subject to dubbing is transferred in the re-encode manner.

The dubbing that is executed at high speeds is referred to as a high-speed dubbing and the dubbing that is executed in the re-encode manner is referred to as a re-encode dubbing.

For example, if the content data subject to dubbing is a partial TS recorded in the DR mode and the removable medium 114 is a Blu-ray disc, the partial TS can be recorded to this Blu-ray disc without conversion, so that the high-speed dubbing can be executed.

If the content data subject to dubbing is an MPEG-PS recorded in the re-encode mode and the removable medium 114 is a DVD, then the MPEG-PS can be recorded to the DVD without conversion, so that the high-speed dubbing can be executed.

On the other hand, if the content data subject to dubbing is a partial TS recorded in the DR mode and the removable medium 114 is a DVD, then the partial TS as the content data subject to dubbing needs to be converted into the MPEG-PS that can be recorded to the DVD, so that the re-encode dubbing is executed in place of the high-speed dubbing.

The removable medium recording control unit 138 controls the drive 141 so as to record the content data supplied from the CODEC 137 to the removable medium 114 loaded on the drive 141.

The removable medium recording control unit 138 is made up of a title database management block 139 and a file system 140 and controls the recording and reproduction of data to and from the removable medium 114 loaded on the drive 141.

To be more specific, in the removable medium recording control unit 138, the title database management block 139 generates a title database for managing the content recorded to the removable medium 114 as with the HDD title database management block 131.

It should be noted that, in dubbing content from the HD 112 to the removable medium 114, the information necessary for the title database management block 139 to generate a title database is supplied from the HD 112 to the title database management block 139 of the removable medium recording control unit 138 via the HD recording control unit 130 and the CODEC 137.

The title database generated by the title database management block 139 is recorded to the removable medium 114 loaded on the drive 141 as required.

The file system 140 executes processing so as to process the content data and so on supplied from the CODEC 137 as a file when these content data and so on are recorded to the removable medium 114 and supplies the processed content data and so on to the drive 141.

Also, the file system 140 outputs the content data and so on reproduced (or read) from the removable medium 114 and supplied from the drive 141, through the output interface 113 via a route, not shown, as required.

In the removable medium recording control unit 138 configured as described above, when the content data subject to dubbing is supplied from the CODEC 137, the file system 140 supplies the supplied content data to the drive 141 to record the content data to the removable medium 114.

Also, in the removable medium recording control unit 138, the title database management block 139 generates a title database for the content recorded to the removable medium 114.

The title database generated by the title database management block 139 is supplied to the drive 141 via the file system 140 for example to be recorded to the removable medium 114.

It should be noted that, as with the HD recording control unit 130, the removable medium recording control unit 138 has capabilities of encrypting and decrypting data and encrypts the data to be supplied to the drive 141 to be recorded to the removable medium 114. In the drive 141, the data (encrypted data) reproduced from the removable medium 114 is decrypted by the removable medium recording control unit 138.

As described above, in dubbing the content recorded to the HD 112 built in the recording apparatus 102 to a recording medium other than the HD 112, the removable medium 114 for example, the dubbing control block 136 controls the HDD title database management block 131 so as to reproduce the title database of the content subject to dubbing from the HD 112 and references the reproduced title database to recognize the CCI of the content subject to dubbing.

If the CCI of the content subject to dubbing is indicative of copy-free for example, the dubbing control block 136 maintains, after the content subject to dubbing is recorded to the HD 112, the title database (and the data of the content subject to dubbing recorded to the HD 112) of the content subject to dubbing recorded to the HD 112 without deleting the title database.

Therefore, in this case, a content copy operation is executed in which the content subject to dubbing is recorded to the removable medium 114 while the content subject to dubbing is kept recorded to the HD 112.

If the CCI of the content subject to dubbing is indicative of no-more-copies for example, the dubbing control block 136 controls the HDD title database management block 131 of the HD recording control unit 130 so as to delete, after the recording of the content subject to dubbing to the removable medium 114, the title database of the content subject to dubbing recorded to the HD 112. It should be noted that the deletion of the title database of the content subject to dubbing disallows the access to the data of the content subject to dubbing even if the data of the content subject to dubbing remains on the HD 112, thereby, substantially, so to speak, deleting the data of the content subject to dubbing from the HD 112.

Therefore, in this case, a content move operation is executed in which the content subject to dubbing is moved from the HD 112 to the removable medium 114.

It should be noted that a move operation is described in Japanese Patent Laid-open No. 2003-016725, for example.

### SUMMARY OF THE INVENTION

As described above, the execution of a move operation as the dubbing of the content of which CCI is no-more-copies may be required for the copyright protection of that content. However, this protection requirement may cause, on the user (or audience) side, dubbing operations to be disabled in the terrestrial digital broadcasting while enabled in the terrestrial analog broadcasting.

To be more specific, in the terrestrial analog broadcasting, no copy guard processing may be executed, so that any content as a program to be broadcast in the terrestrial analog broadcasting can be copied without restriction like any content of which CCI is indicative of copy-free. Consequently, programs of the terrestrial analog broadcasting can be dubbed from the HD 112 to the removable medium 114 and then from the HD 112 to another removable medium or from the removable medium 114 to another removable medium.

As described above, programs in the terrestrial analog broadcasting can be copied without restriction, thereby allowing for a school teacher, for example, to dub a program recorded for teaching to two or more recording media for distribution to students and, if a removable medium recorded with a program becomes unreproducible for some reason, the program can be dubbed to another removable medium again.

On the other hand, in the terrestrial digital broadcasting, the CCIs of most programs are indicative of copy-once.

In the recording apparatus 102, if the content as a program of which CCI is copy-once is recorded to the HD 112, the CCI of that content is changed from copy-once to no-more-copies as described above.

Then, in the recording apparatus 102, the dubbing of the content of which CCI is no-more-copies from the incorporated HD 112 to the removable medium 114 is executed in the form of move; namely, after the content is recorded from the HD 112 to the removable medium 114, the content recorded to the HD 112 is deleted.

As described above, when programs in the terrestrial digital broadcast are dubbed from the HD 112 to the removable medium 114, these programs are deleted from the HD 112, so that, unlike the terrestrial analog broadcasting, these programs cannot be dubbed to two or more removable media, thereby disabling a school teacher to dub a program recorded for teaching to two or more removable media for the distribution to students, for example.

If the removable medium 114 to which the content as a program of the terrestrial digital broadcasting has been dubbed is in a state where this removable medium is unreproducible for some reason or if content data has not been normally recorded to the removable medium 114 in dubbing, the content dubbed to the removable medium 114 cannot be dubbed to another removable medium because the content that has been dubbed to the removable medium 114 was deleted from the HD 112, thereby disabling the content to be dubbed to another removable medium. Consequently, the user loses this content.

In addition, if the data of the content subject to dubbing is a partial TS recorded in the DR mode as described above, for example, and if the removable medium 114 is a Blu-ray disc, then the partial TS that is the data of the content is directly recorded to the removable medium 114 that is a Blu-ray disc without conversion, so that the picture quality and the sound quality of the content recorded to the removable medium 114 are not deteriorated.

On the other hand, if the removable medium 114 is a DVD, a partial TS as the data of the content subject to dubbing is converted into the MPEG-PS that can be recorded to a DVD and then the converted partial TS is recorded to the removable medium 114, thereby causing the picture quality and the sound quality of the content of the MPEG-PS recorded to the removable medium 114 that is a DVD to be deteriorated as compared with the picture quality and the sound quality of the content of the original partial TS.

Consequently, after dubbing the content of a partial TS recorded to the HD 112 to a DVD to check the picture quality and the sound quality of the content recorded to the DVD, if an attempt is made to dub the content to a Blu-ray disc because of the detected deterioration of the picture quality or the sound quality, the content cannot be copied to the Blu-ray disc because the content of the partial TS recorded to the HD 112 has been deleted.

Thus, the dubbing that can be executed in the terrestrial analog broadcasting cannot be executed in the terrestrial digital broadcasting, thereby causing user inconvenience.

On the other hand, unconditionally granting the right of dubbing of the content of which CCI is no-more-copies to users is not appropriate in terms of copyright protection.

Therefore, the present invention addresses the above-identified and other problems associated with related-art methods and apparatuses and solves the addressed problems by providing a recording apparatus, a control method, and a computer program that may be configured to flexibly dub content to solve the user inconvenience, for example.

In carrying out the invention and according to one embodiment thereof, there is provided a recording apparatus for recording content to a content recording medium, which may include dubbing means for recording content recorded to the content recording medium to another content recording medium for dubbing; determining means for determining whether content recorded to the content recording medium satisfies a predetermined condition; and controlling means for recording, if content with copy control information thereof set to no-more-copies indicative of copy prohibition is found not satisfying the predetermined condition, the content from the content recording medium to the another content recording medium and then deleting the content from the content recording medium and, if the content with the copy control information thereof set to no-more-copies is found satisfying the predetermined condition, recording the content from the content recording medium to the another content recording medium and leaving the content on the content recording medium.

In carrying out the invention and according to another embodiment thereof, there is provided a control method or a computer program. The control method may control the recording apparatus for recording content to a content recording medium. The computer program may make a computer control the recording apparatus. The control method or the computer program may include recording content recorded to the content recording medium to another content recording medium for dubbing; determining whether content recorded to the content recording medium satisfies a predetermined condition; and executing control for recording, if content with copy control information thereof set to no-more-copies indicative of copy prohibition is found not satisfying the predetermined condition, the content from the content recording medium to the another content recording medium and then deleting the content from the content recording medium and, if the content with the copy control information thereof set to no-more-copies is found satisfying the predetermined condition, recording the content from the content recording medium to the another content recording medium and leaving the content on the content recording medium.

In the above-mentioned embodiments of the present invention, content recorded to the above-mentioned content recording medium may be recorded to another content recording medium for dubbing. The content recorded to the content recording medium may be determined whether satisfying a predetermined condition. If the content with the copy control information set to no-more-copies indicative of copy prohibition is found not satisfying the predetermined condition, then this content is recorded from the content recording medium to another content recording medium and then is deleted from the content recording medium. On the other hand, if the content with the copy control information set to no-more-copies is found satisfying the predetermined condition, this content is recorded from the content recording medium to another content recording medium and is left on the content recording medium without deletion.

It should be noted that the above-mentioned computer program can be distributed through transmission medium or in recording medium.

The recording apparatus may be a standalone unit or a component block configured for recording in a recording/reproducing apparatus.

According to one embodiment of the invention, content dubbing can be executed with flexibility.

### BRIEF DESCRIPTION OF THE DRAWINGS

FIG. 1 is a block diagram illustrating an exemplary configuration of a related-art broadcasting system;

FIG. 2 is a block diagram illustrating an exemplary configuration of a recording apparatus shown in FIG. 1;

FIG. 3 is a block diagram illustrating an exemplary configuration of a broadcasting system practiced as one embodiment of the invention;

FIG. 4 is a block diagram illustrating an exemplary configuration of a recording apparatus shown in FIG. 3;

FIG. 5 is a block diagram illustrating an exemplary configuration of a CODEC shown in FIG. 4;

FIG. 6 is a flowchart indicative of recording processing;

FIG. 7 is a flowchart indicative of recording processing in DR mode;

FIG. 8 is a flowchart indicative of recording processing in re-encode mode;

FIG. 9 is a flowchart indicative of dubbing processing;

FIG. 10 is a block diagram illustrating an exemplary configuration of a broadcasting system practiced as another embodiment of the invention;

FIG. 11 is a block diagram illustrating an exemplary configuration of a recording apparatus shown in FIG. 10;

FIG. 12 is a block diagram illustrating an exemplary configuration of an external device shown in FIG. 10; and

FIG. 13 is a block diagram illustrating an exemplary configuration of a computer practiced as one embodiment of the invention.

### DETAILED DESCRIPTION

This invention will be described in further detail by way of example with reference to the accompanying drawings. The invention described herein and the embodiments thereof have the following correlation. The description hereof is intended to make sure of the fact that the embodiments supporting the invention described herein are described herein. Therefore, if there is any embodiment that, although described in the description of the preferred embodiment, is not described herein as corresponding to the invention, this does not denote in any manner that such an embodiment does not corresponding to the present invention. Conversely, if any embodiment is described herein as corresponding to the invention, it does not denote in any manner that such an embodiment does not corresponding to other inventions than the present invention.

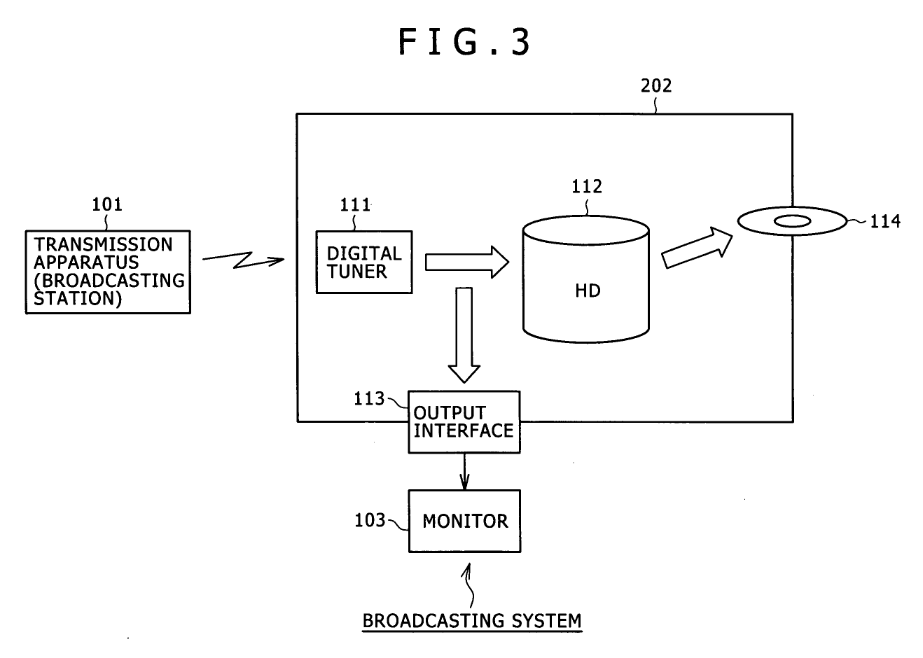

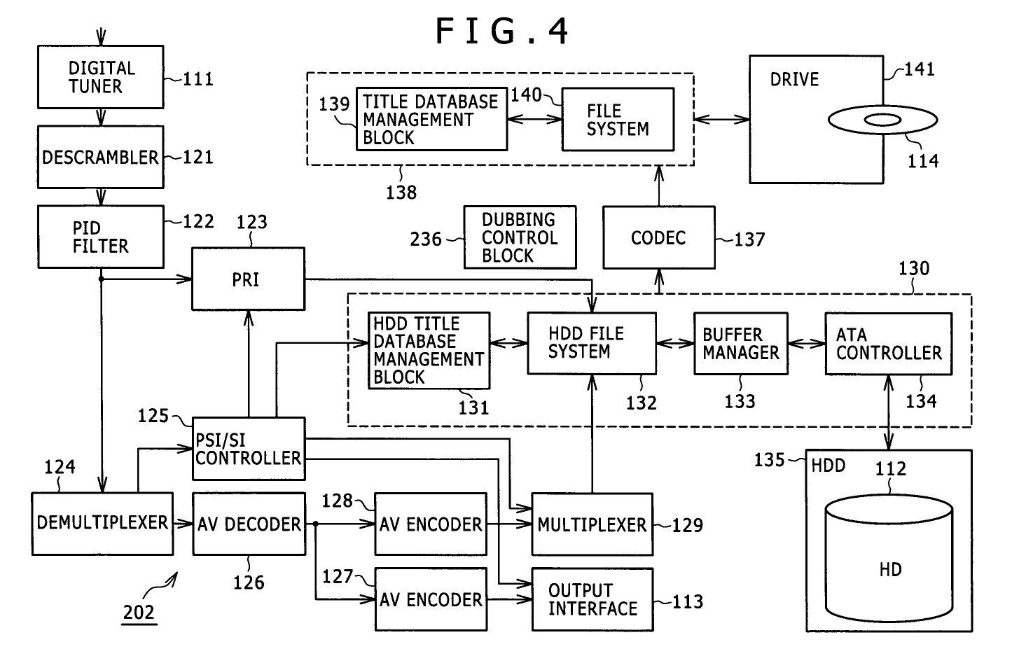

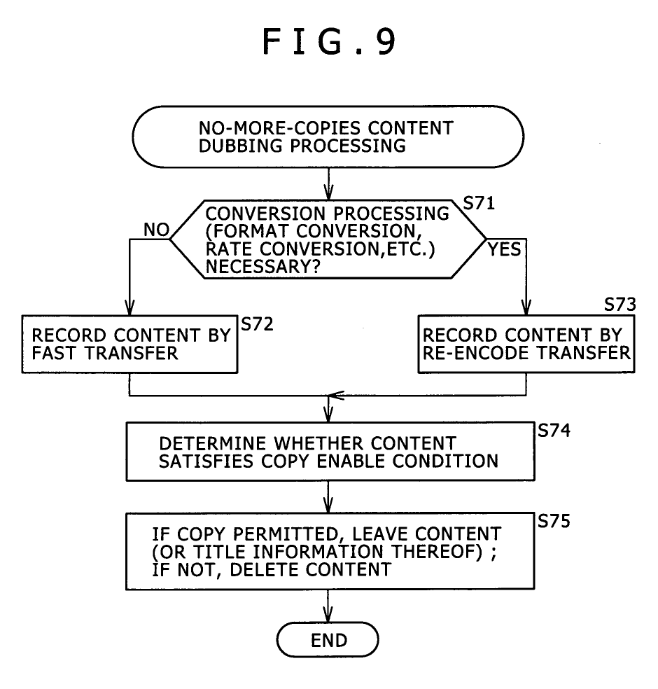

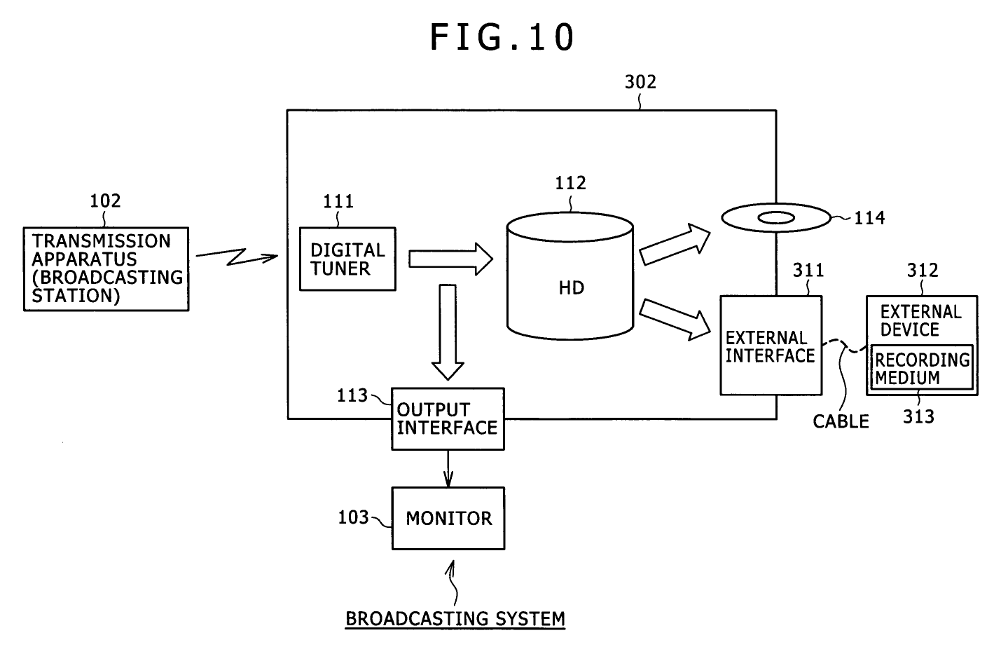

A recording apparatus practiced as one embodiment of the invention is a recording apparatus (for example, a recording apparatus 202 shown in FIG. 3) for recording content to a content recording medium (for example, a HD 112 shown in FIG. 3). This apparatus has: dubbing means (for example, a dubbing control block 236 shown in FIG. 4 for executing steps S72 and S73 shown in FIG. 9) for recording content recorded to the content recording medium to another content recording medium (for example, a removable medium 114 shown in FIG. 3 or a recording medium 313 shown in FIG. 10) for dubbing; determining means (for example, the dubbing control block 236 shown in FIG. 4 for executing step S74 shown in FIG. 9) for determining whether content recorded to the content recording medium satisfies a predetermined condition; and controlling means (for example, the dubbing control block 236 shown in FIG. 4 for executing step S75 shown in FIG. 9) for recording, if content with copy control information thereof set to no-more-copies indicative of copy prohibition is found not satisfying the predetermined condition, the content from the content recording medium to the another content recording medium and then deleting the content from the content recording medium and, if the content with the copy control information thereof set to no-more-copies is found satisfying the predetermined condition, recording the content from the content recording medium to the another content recording medium and leaving the content on the content recording medium.

In the above-mentioned recording apparatus, the content recording medium may be a recording medium (for example, the HD 112 shown in FIG. 3) incorporated in the recording apparatus and another content recording medium may be a recording medium (for example, the removable medium 114 shown in FIG. 3) detachably loaded on the recording apparatus or a recording medium (for example, the recording medium 313 shown in FIG. 10) that is recorded and reproduced by an external device (for example, an external device 312 shown in FIG. 10).

The above-mentioned recording apparatus further has: recording specifying means (for example, a PSI/SI controller 125 shown in FIG. 4) for obtaining, of AV (Audio Visual) data and control data, the copy control information of content from the control data and, if the copy control information is set to copy-once indicative of a permission of copy of one time, setting copy control information to no-more-copies, thereby specifying recording of content to the content recording medium; and title database generating means (for example, a HDD title database management block 131 shown in FIG. 4) for generating a title database for managing content recorded to the content recording medium as specified by the recording specifying means, the title database containing at least the copy control information, wherein the controlling means, if content with the copy control information set to no-more-copies contained in the title database is found not satisfying the predetermined condition, records the content from the content recording medium to the another content recording medium and then deletes the content from the content recording medium and, if content with the copy control information contained in the title database set to no-more-copies is found satisfying the predetermined condition, records the content from the content recording medium to the another content recording medium and leaves the content on the content recording medium.

The control method or the computer program practiced as another embodiment of the invention is the control method for controlling the recording apparatus (for example, the recording apparatus 202 shown in FIG. 3) for recording content to a content recording medium (for example, the HD 112 shown in FIG. 3) and the computer program making a computer control the recording apparatus. The control method or the computer program has the steps of: recording (for example, steps S72 and S73 shown in FIG. 9) content recorded to the content recording medium to another content recording medium (for example, the removable medium 114 shown in FIG. 3 or the recording medium 313 shown in FIG. 10) for dubbing; determining (for example, step S74 shown in FIG. 9) whether content recorded to the content recording medium satisfies a predetermined condition; and executing control (for example, step S75 shown in FIG. 9) for recording, if content with copy control information thereof set to no-more-copies indicative of copy prohibition is found not satisfying the predetermined condition, the content from the content recording medium to the another content recording medium and then deleting the content from the content recording medium and, if the content with the copy control information thereof set to no-more-copies is found satisfying the predetermined condition, recording the content from the content recording medium to the another content recording medium and leaving the content on the content recording medium.

Now, with reference to drawings accompanying hereto, embodiments of the present invention will be described.

Referring to FIG. 3, there is shown an exemplary configuration of a broadcasting system practiced as one embodiment of the present invention.

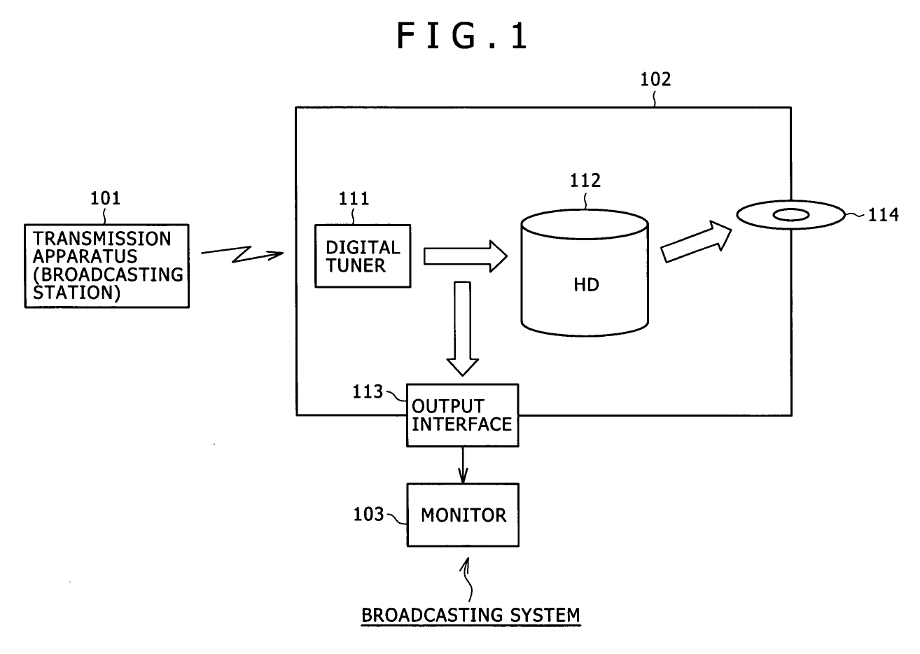

With reference to FIG. 3, components similar to those previously described with reference to FIG. 1 are denoted by the same reference numerals and the description thereof will be skipped for brevity.

To be more specific, the broadcasting system shown in FIG. 3 is generally the same as the broadcasting system shown in FIG. 1 except that a recording apparatus 202 is arranged in place of the recording apparatus 102.

As with the recording apparatus 102 shown in FIG. 1, the recording apparatus 202 has a digital tuner 111, a HD 112, an output interface 113, and the like and is configured the removable loading of a removable medium 114.

With the broadcasting system shown in FIG. 3, an RF signal received from a transmission apparatus 101 is received at the digital tuner 111 and content carried by the received RF signal is supplied to a monitor 103 via the output interface 113 for display.

In addition, with the recording apparatus 202, content carried by an RF signal received at the digital tuner 111 is recorded to the HD 112 as required.

Further, the recording apparatus 202 is configured to dub, as required, the content recorded to the HD 112 onto the removable medium 114 or the like loaded on the recording apparatus 202.

Referring to FIG. 4, there is shown a detailed exemplary configuration of the recording apparatus 202.

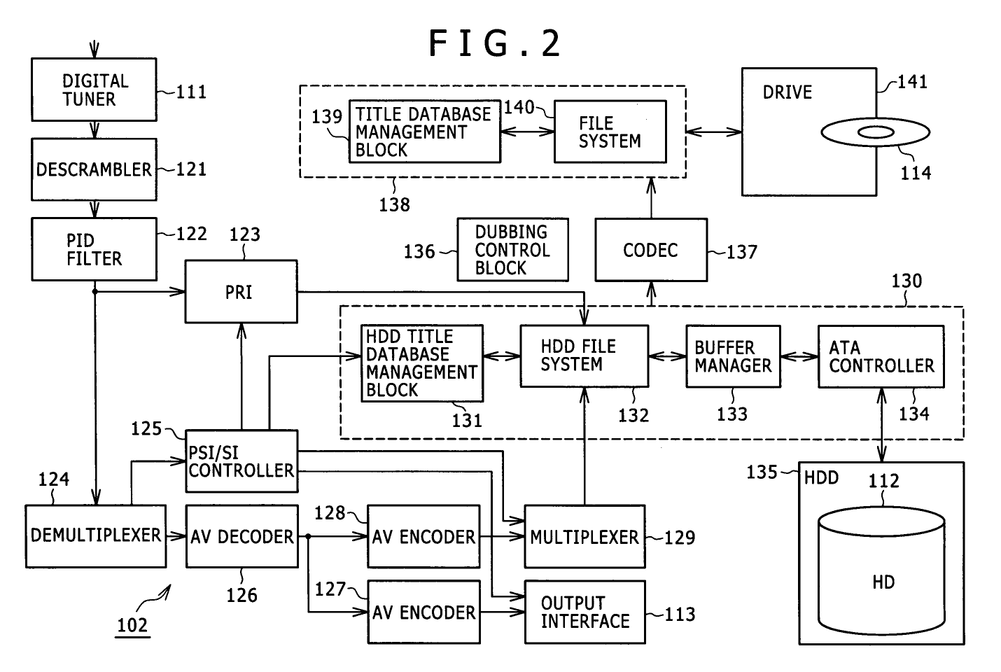

With reference to FIG. 4, components similar to those previously described with reference to FIG. 2 are denoted by the same reference numerals and the description thereof will be skipped for brevity.

To be more specific, the recording apparatus 202 is configured in generally the same manner as the recording apparatus 102 shown in FIG. 2 except that a dubbing control block 236 is arranged in place of the dubbing control block 136.

As with the dubbing control block 136 shown in FIG. 2, in dubbing the content recorded to the HD 112 onto the removable medium 114 or the like, the dubbing control block 236 controls a HD recording control unit 130, a CODEC 137, a removable medium recording control unit 138, and the like.

If the CCI of the content subject to dubbing is no-more-copies, the dubbing control block 136 of the recording apparatus 102 shown in FIG. 2 controls the HD recording control unit 130 so as to always delete the content recorded from the HD 112 to the removable medium 114; however, in the recording apparatus 202 shown in FIG. 4, the dubbing control block 236 is configured to determine whether the content having the no-more-copies CCI satisfies a predetermined condition.

If the content having the no-more-copies CCI is found not satisfying a predetermined condition, then, as with the dubbing control block 136, the dubbing control block 236 controls the HD recording control unit 130 so as to record the content from the HD 112 to the removable medium 114 and then delete the content from the HD 112. If the content having the no-more-copies CCI is found satisfying a predetermined condition, then the dubbing control block 236 controls the HD recording control unit 130 so as to record the content from the HD 112 to the removable medium 114 and then leave the content undeleted on the HD 112.

Consequently, with the recording apparatus 202, if the content having the no-more-copies CCI satisfies a predetermined condition, this content is left undeleted on the HD 112 after having been recorded from the HD 112 to the removable medium 114, so that this content can be dubbed to the removable medium 114 again or dubbed to another removable medium.

It should be noted that the dubbing control block 236 is configured to control each of component blocks of the recording apparatus 202 as required and therefore is connected with component blocks subject to control, the connection lines between the dubbing control block 236 and the component blocks being omitted for brevity.

As with the recording apparatus 102 shown in FIG. 2, the recording apparatus 202 having the above-mentioned configuration can record content that is a digital broadcast program to the HD 112. Also, the recording apparatus 202 can dub the content recorded to the HD 112 to the removable medium 114.

With the recording apparatus 202, in a content dubbing operation, the content subject to dubbing recorded to the HD 112 is supplied to the drive 141 to be recorded to the removable medium 114 via a HD recording control unit 130, a CODEC 137, and a removable medium recording control unit 138, as with the recording apparatus 102 shown in FIG. 2.

Then, in the above-mentioned process, the content data is converted by the CODEC 137 as required, as described above with reference to FIG. 2.

To be more specific, for example, if the content data subject to dubbing is a partial TS recorded in the DR mode and the removable medium 114 is a Blu-ray disc, then the partial TS can be recorded to a Blu-ray disc without conversion, so that a high-speed transfer operation is executed in which the partial TS that is the content data subject to dubbing reproduced from the HD 112 is supplied to the removable medium recording control unit 138 by bypassing the CODEC 137.

Consequently, in the above-mentioned case, high-speed dubbing can be executed.

Also, for example, if the content data subject to dubbing is a partial TS recorded in the DR mode but the removable medium 114 is a DVD, then the partial TS that is the content data subject to dubbing needs to be converted into MPEG-PS in which the content data can be recorded to a DVD, so that a re-encode transfer operation is executed in which the partial TS that is the content data subject to dubbing reproduced from the HD 112 is converted by the CODEC 137 into MPEG-PS and the resultant MPEG-PS content data is supplied to the removable medium recording control unit 138.

Consequently, in the above-mentioned case, re-encode dubbing is executed.

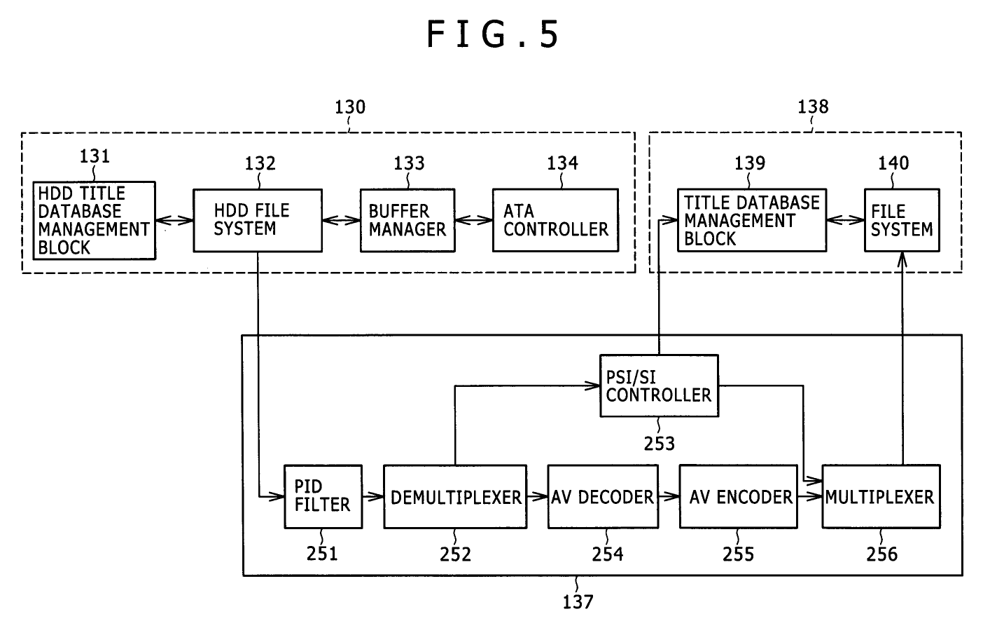

Referring to FIG. 5, there is shown an exemplary configuration of the CODEC 137 configured to convert content data from partial TS to MPEG-PS in which the content data can be recorded to a DVD as described above.

In FIG. 5, the CODEC 137 is made up of a PID filter 251, a demultiplexer 252, a PSI/SI controller 253, an AV decoder 254, an AV encoder 255, a multiplexer 256, and the like.

In dubbing from the HD 112 (FIG. 4) to the removable medium 114, a partial TS that is the content data subject to dubbing reproduced from the HD 112 is supplied from the HDD file system 132 of the HD recording control unit 130 to the PID filter 251 of the CODEC 137.

The PID filter 251 extracts, from TS packets making up a partial TS received from the HDD file system 132 of the HD recording control unit 130, a TS packet having PID necessary for converting the partial TS into MPEG-PS and supplies the extracted TS packet to the demultiplexer 252.

The demultiplexer 252 separates the TS packet of partial packet TS received from the PID filter 251 into image, audio, and control data (of the TS packet). Then, the demultiplexer 252 supplies the AV data of image and audio of the content to the AV decoder 254 and the control data to the PSI/SI controller 253.

As with the PSI/SI controller 125 (FIG. 4), the PSI/SI controller 253 configures the PSI/SI by analyzing the control data received from the demultiplexer 252.

Further, on the basis of a digital copy control descriptor that is the CCI contained in the PSI/SI, the PSI/SI controller 253 recognizes the CCI of the content subject to dubbing and, if the recognized CCI is found to be no-more-copies for example, issues a command for making the CCI of the content subject to dubbing be no-more-copies to the multiplexer 256 and the title database management block 139 of the removable medium recording control unit 138.

On the other hand, the AV decoder 254 decodes the content data received from the demultiplexer 252. Namely, the content data received from the demultiplexer 252 is encoded by the MPEG algorithm, so that the AV decoder 254 decodes the content data encoded by the MPEG algorithm.

Next, the AV decoder 254 supplies the decoded baseband content data (AV data) to the AV encoder 255.

As with the AV encoder 128 (FIG. 4), the AV encoder 255 executes appropriate signal processing on the baseband content data received from the AV decoder 254 to encode into the data having a predetermined format and supplies the resultant data to the multiplexer 256.

The multiplexer 256 multiplexes the content data of a predetermined format received from the AV encoder 255 with the CCI and so on specified by the PSI/SI controller 253 to generate multiplexed data that is MPEG-PS in which the content data can be recorded to a DVD and supplies the resultant MPEG-PS content data to the file system 140 of the removable medium recording control unit 138.

In the removable medium recording control unit 138, the file system 140 supplies the MPEG-PS that is the content data received from the multiplexer 256 of the CODEC 137 to the drive 141 (FIG. 4) to record the MPEG-PS as the content data to the removable medium 114.

Further, in the removable medium recording control unit 138, the title database management block 139 generates a title database containing the CCI specified by the PSI/SI controller 253 of the CODEC 137 for the content recorded (or dubbed) to the removable medium 114.

The title database generated by the title database management block 139 is supplied to the drive 141 via the file system 140, for example, to be recorded to the removable medium 114.

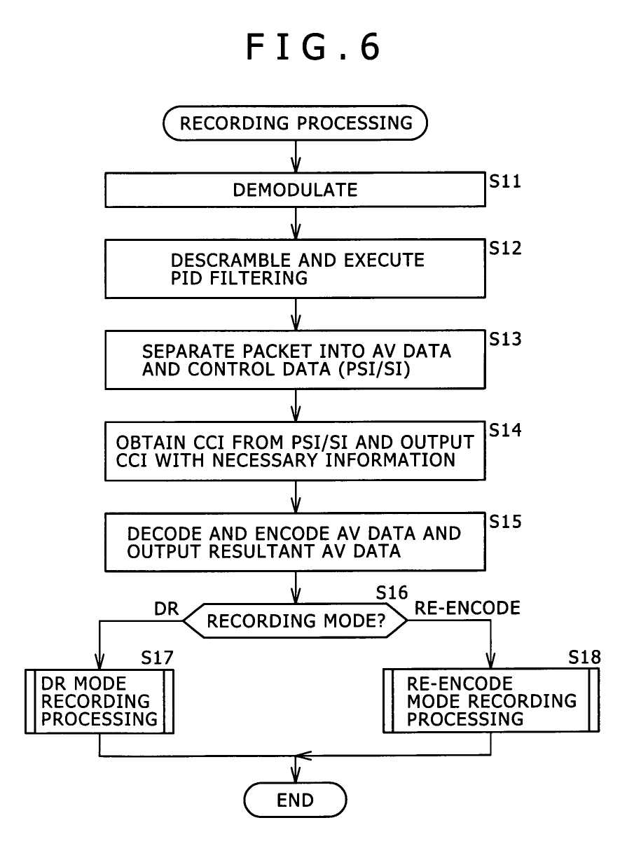

The following describes recording processing in which the recording apparatus 202 shown in FIG. 4 records content that is a digital broadcast program to the HD 112, with reference to the flowchart shown in FIG. 6.

In step S11, the digital tuner 111 receives an RF signal of digital broadcasting transmitted from the transmission apparatus 101 (FIG. 3) and executes signal processing, such as demodulation and so on, on the received RF signal to get the MPEG-TS of full TS, supplying the obtained MPEG-TS of full TS to the descrambler 121.

The procedure goes from step S11 to S12, in which the descrambler 121 executes descramble processing in which the full TS received from the digital tuner 111 is descrambled and supplies the descrambled full TS to the PID filter 122.

Further, in step S12, the PID filter 122 extracts, from TS packets making up the full TS received from the descrambler 121, a TS packet having a predetermined value of PID, namely, a TS packet containing the AV data of image and audio and the control data of the content (the content subject to recording) to be recorded to the HD 112 and supplies the extracted TS packet to the PRI 123 and the demultiplexer 124, upon which the procedure goes to step S13.

In step S13, the demultiplexer 124 separates the TS packet of the full TS received from the PID filter 122 into image, audio, and control data (of the TS packet) and supplies the AV data of image and audio of the content to the AV decoder 126 and the control data to the PSI/SI controller 125, upon which the procedure goes to step S14.

In step S14, the PSI/SI controller 125 configures the PSI/SI from the control data received from the demultiplexer 124 and extracts necessary information from the configured PSI/SI, supplying the extracted information to the PRI 123 and the HD recording control unit 130.

Further, the PSI/SI controller 125 recognizes the CCI of the content subject to recording from a digital copy control descriptor contained in the PSI/SI and obtains, from this CCI, the CCI (hereafter appropriately referred to as updated CCI) for use in recording and outputting the content subject to recording, supplying the obtained CCI to the output interface 113, the PRI 123, the multiplexer 129, and the HD recording control unit 130.

If the CCI of the content subject to recording recognized from the digital copy control descriptor contained in the PSI/SI is indicative of copy-free, then the PSI/SI controller 125 makes the updated CCI copy-free. If the CCI of the content subject to recording recognized from the digital copy control descriptor contained in the PSI/SI is indicative of copy-once, then the PSI/SI controller 125 makes the updated CCI no-more-copies.

It should be noted that, if the CCI of the content subject to recording recognized from the digital copy control descriptor contained in the PSI/SI is no-more-copies or copy-never, the recording of this content to the HD 112 is disabled and therefore is not executed.

Then, the procedure goes from step S14 to step S15, in which the AV decoder 126 decodes the content data received from the demultiplexer 124 and supplies the resultant baseband content data (AV data) to the AV encoder 127 and the AV encoder 128.

Further, in step S15, the AV encoder 127 encodes the content data received from the AV decoder 126 into data having a format compliant with a device (the monitor 103 shown in FIG. 3 for example) connected to the output interface 113 and supplies the resultant content data to the output interface 113.

The output interface 113 generates a signal copy-protected in a predetermined manner from the content data received from the AV encoder 127 in accordance with the CCI obtained from the PSI/SI controller 125 and outputs the generated signal.

Next, the procedure goes from step S15 to step S16, in which the PRI 123 determines whether the recording mode is set to the DR mode or the re-encode mode.

The recording mode can be set by the user's operating a remote commander, not shown, of the recording apparatus 202, for example.

In step S16, if the recording mode is found set to the DR mode, the procedure goes to step S17, in which the DR mode recording processing is executed to record the content subject to recording to the HD 112.

If the recording mode is found set to the re-encode mode in step S16, then the procedure goes to step S18, in which the re-encode mode recording processing is executed to record the content subject to recording to the HD 112.

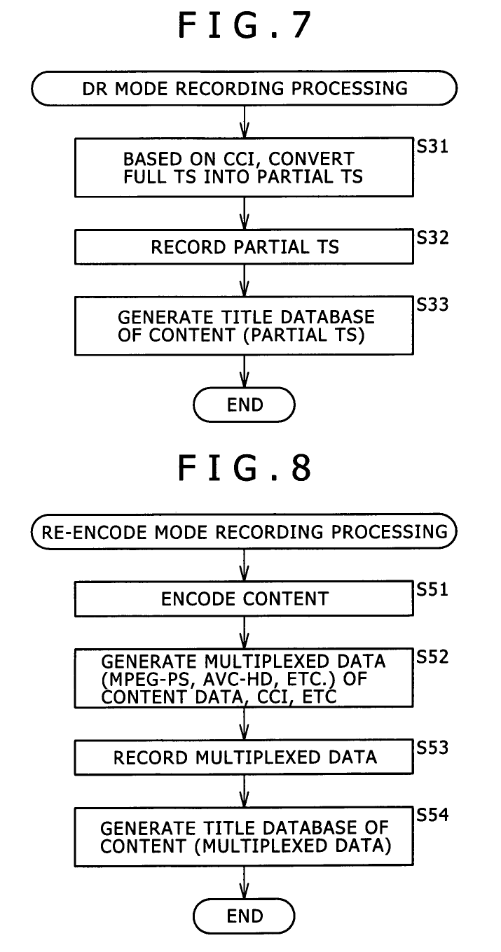

The following describes details of the DR mode recording processing executed in step S17 of FIG. 6 with reference the flowchart shown in FIG. 7.

In the DR mode recording processing, in step S31, the PRI 123 generates a partial TS from the full TS received from the PID filter 122 as the content data subject to recording and supplies the generated partial TS to the HD recording control unit 130.

In generating the partial TS in step S31, the CCI of the content subject to recording is converted to the updated CCI that is supplied from the PSI/SI controller 125 in step S14 shown in FIG. 6.

Namely, as described above, if the CCI of the content is copy-once, for example, then the PSI/SI controller 125 supplies no-more-copies to the PRI 123 and the HD recording control unit 130 as the updated CCI (or specifies a change from copy-once to no-more-copies).

In step S31, the PRI 123 changes, from copy-once to no-more-copies, a digital copy control descriptor as the CCI contained in the control data in the full TS received from the PID filter 122 in accordance with the updated CCI received from the PSI/SI controller 125 or adds a new descriptor as the CCI of no-more-copies into the control data.

Then, the procedure goes from step S31 to step S32, in which the HD recording control unit 130 records the partial TS that is the content data subject to recording received from the PRI 123 to the HD 112, upon which the procedure goes to step S33.

Namely, in the HD recording control unit 130, the HDD file system 132 supplies the partial TS received from the PRI 123 to the buffer manager 133. The buffer manager 133 temporarily stores the partial TS received from the HDD file system 132 and then supplies the stored partial TS to the ATA controller 134. In the ATA controller 134, the partial TS received from the buffer manager 133 is encrypted to be supplied to the HDD 135. In the HDD 135, the encrypted partial TS received from the ATA controller 134 is recorded to the HD 112.

In step S33, in the HD recording control unit 130, the HDD title database management block 131 generates a title database for the content recorded to the HD 112 in the form of partial TS.

Namely, on the basis of the information and so on supplied from the PSI/SI controller 125 to the HD recording control unit 130, the HDD title database management block 131 generates a title database containing the title, channel information, broadcast form identification information, and CCI (the updated CCI received from the PSI/SI controller 125) of the content of the partial TS recorded to the HD 112.

The title database generated by the HDD title database management block 131 is supplied to the HDD 135 via the HDD file system 132, the buffer manager 133, and the ATA controller 134, for example, to be recorded to the HD 112.

The following describes details of the re-encode mode recording processing that is executed in step S18 of FIG. 6 with reference to the flowchart shown in FIG. 8.

In the re-encode mode recording processing, in step S51, the AV encoder 128 encodes, by MPEG2 or MPEG4 for example, the baseband content data received from the AV decoder 126 and supplies the encoded content data having a predetermined format to the multiplexer 129, upon which the procedure goes to step S52.

In step S52, the multiplexer 129 multiplexes the content data having a predetermined format received from the AV encoder 128 with the updated CCI and so on received from the PSI/SI controller 125 in step S14 of FIG. 6 to generate multiplexed data of MPEG-PS or AVC-HD in which the content data can be recorded to a DVD, thereby supplying the multiplexed data to the HD recording control unit 130, upon which the procedure goes to step S53.

In step S53, the HD recording control unit 130 records the multiplexed data received from the multiplexer 129 to the HD 112 as in step S32 shown in FIG. 7, upon which the procedure goes to step S54.

In step S54, in the HD recording control unit 130, the HDD title database management block 131 generates a title database for the content recorded to the HD 112 in the form of multiplexed data.

Namely, on the basis of the information and so on supplied from the PSI/SI controller 125 to the HD recording control unit 130, the HDD title database management block 131 generates a title database containing the title, channel information, broadcast form identification information, and CCI (the updated CCI received from the PSI/SI controller 125) of the content of the multiplexed data recorded to the HD 112.

The title database generated by the HDD title database management block 131 is supplied to the HDD 135 via the HDD file system 132, the buffer manager 133, and the ATA controller 134, for example, to be recorded to the HD 112.

It should be noted that the HDD title database management block 131 reproduces (or reads), as required, the title database from the HD 112 via the ATA controller 134, the buffer manager 133, and the HDD file system 132 and supplies the title database to necessary component blocks, such as the dubbing control block 236.

Next, the recording apparatus 202 can dub the content recorded to the incorporated HD 112 to a recording medium other than the HD 112, namely, the removable medium 114, for example, loaded on the drive 141.

The following describes dubbing processing for dubbing content of which CCI is no-more-copies from the HD 112 to the removable medium 114, with reference to the flowchart shown in FIG. 9.

Dubbing processing starts when the user specifies the content subject to recording and operates a remote commander, not shown, for example, of the recording apparatus 202 so as to execute dubbing.

In step S71, the dubbing control block 236 determines whether conversion processing is necessary for dubbing the content subject to dubbing from the HD 112 to the removable medium 114.

If the similarity between the format of content data subject to dubbing recorded to the HD 112 and the format of data recorded to the removable medium 114 is high, namely, if the content data subject to dubbing is a partial TS recorded in the DR mode and the removable medium 114 is a Blu-ray disc in which a partial TS can be recorded in bit-wise copy or the content data subject to dubbing is MPEG-PS recorded in the re-encode mode and the removable medium 114 is a DVD in which MPEG-PS can be recorded in bit-wise copy, for example, then conversion processing is found unnecessary in step S71.

If the similarity between the format of content data subject to dubbing recorded to the HD 112 and the format of data recorded to the removable medium 114 is low, namely, if the content data subject to dubbing is a partial TS recorded in the DR mode and the removable medium 114 is a DVD in which MPEG-PS can be recorded, for example, then the conversion processing for converting the partial TS into MPEG-PS in which the data can be recorded to a DVD is found necessary in step S71.

If the conversion processing is found unnecessary in step S71, then the procedure goes to step S72, in which the dubbing control block 236 records the content data subject to dubbing recorded to the HD 112 to the removable medium 114 for dubbing.

It should be noted that the transmission of data from the HD 112 to the removable medium 114 when recording the content subject to dubbing recorded to the HD 112 to the removable medium 114 is executed in high-speed transfer in step S72.

Namely, in step S72, the dubbing control block 236 controls the HD recording control unit 130 so as to reproduce the content data subject to dubbing from the HD 112.

In the HD recording control unit 130, the content data subject to dubbing is reproduced from the HD 112 in the HDD 135 under the control of the dubbing control block 236 and the reproduced content data is supplied to the CODEC 137 via the ATA controller 134, the buffer manager 133, and the HDD file system 132.

The CODEC 137 supplies the content data received from the HD recording control unit 130 to the removable medium recording control unit 138 without executing the conversion processing. In the removable medium recording control unit 138, when the content data subject to dubbing is received from the CODEC 137, the file system 140 supplies the received content data to the drive 141 to record to the removable medium 114.

Also, in the removable medium recording control unit 138, the title database management block 139 generates a title database for the content subject to dubbing recorded to the removable medium 114.

To be more specific, the dubbing control block 236 controls the HD recording control unit 130 so as to reproduce the title database of the content subject to dubbing from the HD 112. Under the control of the dubbing control block 236, the HD recording control unit 130 reproduces the title database of the content subject to dubbing from the HD 112 and supplies the information (hereafter appropriately referred to as title information) contained on the reproduced title database to the removable medium recording control unit 138 via the CODEC 137.

In the title database management block 139 of the removable medium recording control unit 138, a title database is generated for the content subject to dubbing recorded to the removable medium 114 by use of the title information supplied as described above.

The title database generated in the title database management block 139 is supplied to the drive 141 via the file system 140, for example, to be recorded to the removable medium 114.

On the other hand, if the conversion processing is found necessary in step S71, then the procedure goes to step S73, in which the dubbing control block 236 records the content subject to dubbing recorded to the HD 112 to the removable medium 114 for dubbing.

It should be noted that, in step S73, the transmission of data from the HD 112 to the removable medium 114 when recording the content subject to dubbing recorded to the HD 112 to the removable medium 114 is executed in re-encode transfer.

Namely, in step S73, the dubbing control block 236 controls the HD recording control unit 130 so as to reproduce the content data subject to processing from the HD 112.

In the HD recording control unit 130, the content data subject to dubbing is reproduced from the HD 112 incorporated in the HDD 135 and the reproduced content data is supplied to the CODEC 137 via the ATA controller 134, the buffer manager 133, and the HDD file system 132 under the control of the dubbing control block 236.

The CODEC 137 executes the conversion processing on the content data received from the HD recording control unit 130 and supplies the converted content data to the removable medium recording control unit 138. In the removable medium recording control unit 138, when the content data subject to dubbing is supplied from the CODEC 137, the file system 140 supplies the received content data to the drive 141 to record to the removable medium 114.

Also, in the removable medium recording control unit 138, as in step S72, the title database management block 139 generates a title database for the content subject to dubbing recorded to the removable medium 114, recording the generated title database to the removable medium 114 as required.

As described above, in step S72 or step S73, after the content subject to dubbing recorded to the HD 112 has been recorded to the removable medium 114, the procedure goes to step S74, in which the dubbing control block 236 determines whether the content subject to dubbing recorded to the HD 112 satisfies a predetermined condition, upon which the procedure goes to step S75.

The above-mentioned condition denotes a copy enable condition that permits the copying of content with the CCI set to copy-once from the HD 112 of the recording apparatus 202 to the removable medium 114, in which the source content is left undeleted on the HD 112 unlike the case of moving.

The copy enable condition may include that the content subject to dubbing with the CCI set to copy-once is the content that is a program broadcast by terrestrial digital broadcasting, for example.

Whether the content recorded to the HD 112 is a program broadcast by terrestrial digital broadcasting can be recognized (or determined) by referencing the broadcasting form identification information contained in the title database for the content recorded to the HD 112.

In step S75, in accordance with the determination in step S74 whether the content subject to dubbing satisfies the copy enable condition or not, the dubbing control block 236 controls the HD recording control unit 130 so as to delete the content subject to dubbing from the HD 112 or leave the content subject to dubbing undeleted on the HD 112.

Namely, if the content subject to dubbing does not satisfy the copy enable condition, if the content subject to dubbing is not a program broadcast by terrestrial digital broadcasting, to be more specific, or if the content subject to dubbing is a program broadcast by BS digital broadcasting or CS digital broadcasting, then the dubbing control block 236 controls the HD recording control unit 130 so as to delete the content subject to dubbing from the HD 112.

Under the control of the dubbing control block 236, the HD recording control unit 130 deletes the content subject to dubbing from the HD 112. Therefore, in this case, the content subject to dubbing is moved from the HD 112 to the removable medium 114.

On the other hand, if the content subject to dubbing satisfies the copy enable condition, if the content subject to dubbing is a program broadcast by terrestrial digital broadcasting for example, then the dubbing control block 236 controls the HD recording control unit 130 so as to leave the content subject to dubbing on the HD 112.

Under the control of the dubbing control block 236, the HD recording control unit 130 leaves the content subject to dubbing on the HD 112. Therefore, in this case, the content subject to dubbing is copied from the HD 112 to the removable medium 114.

As described above, in the recording apparatus 202, if the CCI of the content subject to dubbing is no-more-copies but if this content satisfies the predetermined copy enable condition, namely, if the content subject to dubbing is a program broadcast by the terrestrial digital broadcasting, the content subject to dubbing is left on the HD 112 rather than deleting from the HD 112 after recording the content subject to dubbing from the HD 112 to the removable medium 114 as with the recording apparatus 102 in FIG. 1. Therefore, the content, namely, a program broadcast by the terrestrial digital broadcasting can be dubbed to the removable medium 114 again or further dubbed to another removable medium, for example.

Consequently, the above-mentioned embodiment of the invention can prevent a problem that functions enabled in the terrestrial analog broadcasting cannot be executed in the terrestrial digital broadcasting, thereby overcoming the user inconvenience involved in the recording apparatus 102 shown in FIG. 1.

If the content with the CCI set to no-more-copies is a program broadcast by the terrestrial digital broadcasting and, after recording this content from the HD 112 to the removable medium 114, this content is copied from the HD 112 without deletion, the CCI of the content recorded to the removable medium 114 is no-more-copies, so that, as long as an (authorized) device that executes copy protection in accordance with CCI is used, the content recorded to the removable medium 114 with the CCI set to no-more-copies can be neither copied to another recording medium nor distributed via the Internet for example, thereby providing copyright protection.

Further, in the recording apparatus 202, the processing of recording the content with the CCI set to copy-once to the HD 112 is common to that of the recording apparatus 102 shown in FIG. 1 including the changing of the CCI of that content from copy-once to no-more-copies. The difference from the processing by the recording apparatus 102 shown in FIG. 1 lies only in that the dubbing of each program of the terrestrial digital broadcasting is executed not by move but by copy, of the content with the CCI set to no-more-copies recorded to the HD 112.

Therefore, the recording apparatus 202 can be realized only by locally modifying the software so as to execute the dubbing of each program of the terrestrial digital broadcasting by not move but by copy, of the content with the CCI set to no-more-copies recorded to the HD 112.

Consequently, the realization of the recording apparatus 202 needs less processes for installation and evaluation (or testing).

Further, in the recording apparatus 202, as with the recording apparatus 102, the content with the CCI set to no-more-copies recorded to the HD 112 can be recorded from the HD 112 to the removable medium 114 without rewriting the CCI, so that, if the content subject to dubbing needs no conversion processing, the content subject to dubbing can be dubbed at high speeds.

It should be noted that the recording apparatus 202 can be realized by downloading the above-mentioned locally modified software on the recording apparatus 102 shown in FIG. 1, so that the user who purchased the recording apparatus 102 shown in FIG. 1 before the recording apparatus 202 can obtain the same merits as those enjoyed by the user of the recording apparatus 202.

In addition, unlike the recording apparatus 102 shown in FIG. 1, the recording apparatus 202 can execute functions enabled by the terrestrial analog broadcasting also in the terrestrial digital broadcasting, so that the recording apparatus 202 is higher in user convenience than the recording apparatus 102, providing a definite difference from the recording apparatus 102. This would be a great advantage in marketing if the recording apparatus 202 can be commercialized before competitors.

For programs with the CCI set to copy-once among free-of charge or charged programs broadcast by the BS digital broadcasting or the CS digital broadcasting, for example, the CCI is changed from copy-once to no-more-copies when the content is recorded to the HD 112 and the dubbing from the HD 112 to the removable medium 114 or the like can be executed by a move operation.

For terrestrial digital broadcast programs of the content with the CCI set to no-more-copies recorded to the HD 112, it is practicable for these programs to appear for the user as if these programs are the content with the CCI set to copy-once.

Referring to FIG. 10, there is shown an exemplary configuration of the broadcasting system practiced as another embodiment of the present invention.

With reference to FIG. 10, components similar to those previous described with reference to FIG. 1 or FIG. 3 are denoted by the same reference numerals and the description thereof will be skipped.

Namely, the broadcasting system shown in FIG. 10 is generally the same in configuration as the broadcasting system shown in FIG. 3 except that a recording apparatus 302 is arranged in place of the recording apparatus 202.

As with the recording apparatus 102 shown in FIG. 1 and the recording apparatus 202 shown in FIG. 3, the recording apparatus 302 has a digital tuner 111, a HD 112, an output interface 113, and so on, on which a removable medium 114 is removably loaded.

In addition, the recording apparatus 302 is connected with an external device 312 and has an external interface 311 for interfacing the external device 312, which is different from the configuration of the recording apparatus 202 shown in FIG. 3.

In the broadcasting system shown in FIG. 10 configured as described above, as with broadcasting system shown in FIG. 3, an RF signal from the transmission apparatus 101 is received at the digital tuner 111 of the recording apparatus 302 and the content carried by that RF signal is supplied to a monitor 103 via an output interface 113 for display and so on.

In addition, in the recording apparatus 302, the content carried by the RF signal received at the digital tuner 111 is supplied (or recorded) to the HD 112 as occasions demand.

Further, in the recording apparatus 302, the content recorded to the HD 112 can be dubbed, as occasions demand, to the removable medium 114 loaded on the recording apparatus 302.

If the external interface 311 is connected with the external device 312, the external device 312 can dub, as occasions demand, the content recorded to the HD 112 to a recording medium 313 that can be accessed by the connected external device 312 for recording and reproduction.

Namely, the external device 312 is a portable terminal represented by PSP (registered trademark) of Sony Computer Entertainment Corporation and iPod (registered trademark) of Apple Computer Incorporated, for example, or a stationary recorder (a DVD recorder or a personal computer that also functions as a DVD recorder, for example) or the like and incorporates or removably loaded with the recording medium 313 that can be accessed by the external device 312 itself for recording and reproduction.

As with the recording apparatus 202 shown in FIG. 3, the recording apparatus 302 configured to dub the content recorded to the HD 112 to the removable medium 114 and the recording medium 313 of the external device 312 connected to the external interface 311.

It should be noted that the connection with the external device 312 can be done through USB (Universal Serial Bus), for example.

The recording medium 313 can be implemented by a hard disk or a semiconductor memory, for example.

It should be noted that, in order to prevent unauthorized copy, the communication between the external interface 311 and the external device 312 is authenticated and, if the authentication is found successful, the communication therebetween is allowed. Also, if the authentication is found successful, the external interface 311 encrypts the content and then transmits the encrypted content to the external device 312. The external device 312 decrypts the received encrypted content and then encrypts the decrypted content again before recording to the recording medium 313.

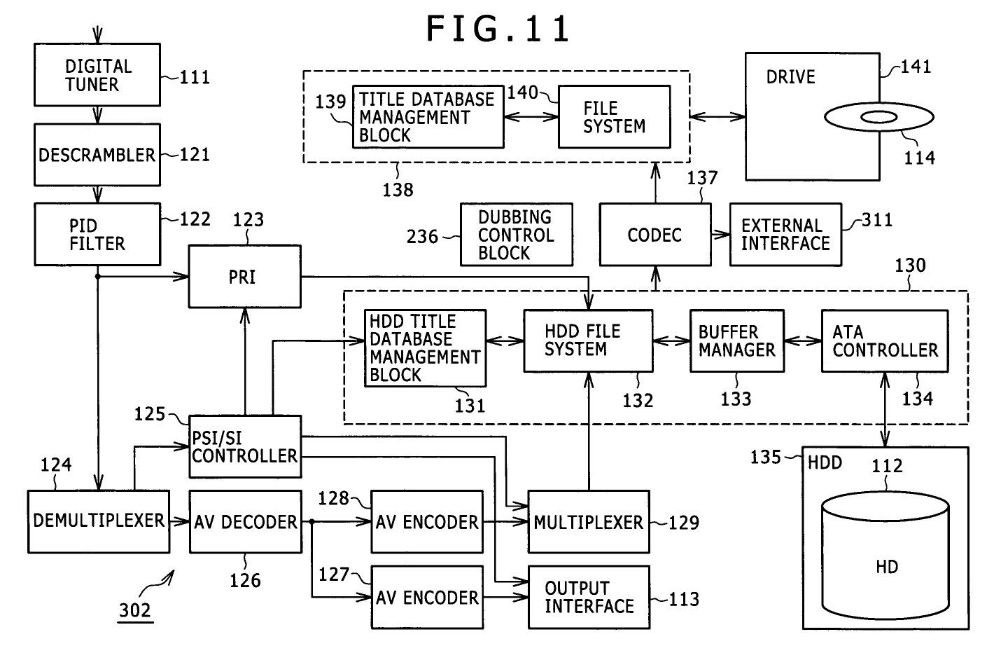

Referring to FIG. 11, there is shown a detailed exemplary configuration of the recording apparatus 302 shown in FIG. 10.

With reference to FIG. 11, components similar to those previous described with reference to FIG. 2 or FIG. 4 are denoted by the same reference numerals and the description thereof will be skipped.

Namely, the recording apparatus 302 is configured in generally the same manner as the recording apparatus 202 shown in FIG. 4 except for the external interface 311.

In the recording apparatus 302, the external interface 311 is connected to the CODEC 137 and, if the content recorded to the HD 112 is dubbed to the recording medium 313 incorporated in the external device 312 (FIG. 10) connected to the external interface 311 (or removably connected to the external device 312), this dubbing is executed by recording the content from the HD 112 to the recording medium 313 contained in the external device 312 via the HD recording control unit 130, the CODEC 137, and the external interface 311.

It should be noted that, if the content data subject to dubbing is the MPEG-PS recorded in the re-encode mode and the external device 312 is able to record the MPEG-PS to the incorporated recording medium 313 without any change, the content data subject dubbing need not be converted, so that the MPEG-PS as the content data subject to dubbing reproduced from the HD 112 is supplied, in the high-speed transfer, to the external interface 311 by bypassing the CODEC 137 to be supplied from the external interface 311 to the external device 312.

Consequently, high-speed dubbing can be executed in the above-mentioned case.

On the other hand, if the content data subject to dubbing is a partial TS recorded in the DR mode and the MPEG-PS can be recorded to the recording medium 313 in the external device 312 but the partial TS may not be recorded thereto, the partial TS that is the content subject to dubbing has to be converted into the MPEG-PS. Therefore, the partial TS that is the content data subject to dubbing reproduced from the HD 112 is converted by the CODEC 137 and the resultant MPEG-PS is supplied to the external interface 311 to be further supplied to the external device 312 in the re-encode transfer manner.

Consequently, re-encode dubbing is executed in the above-mentioned case.

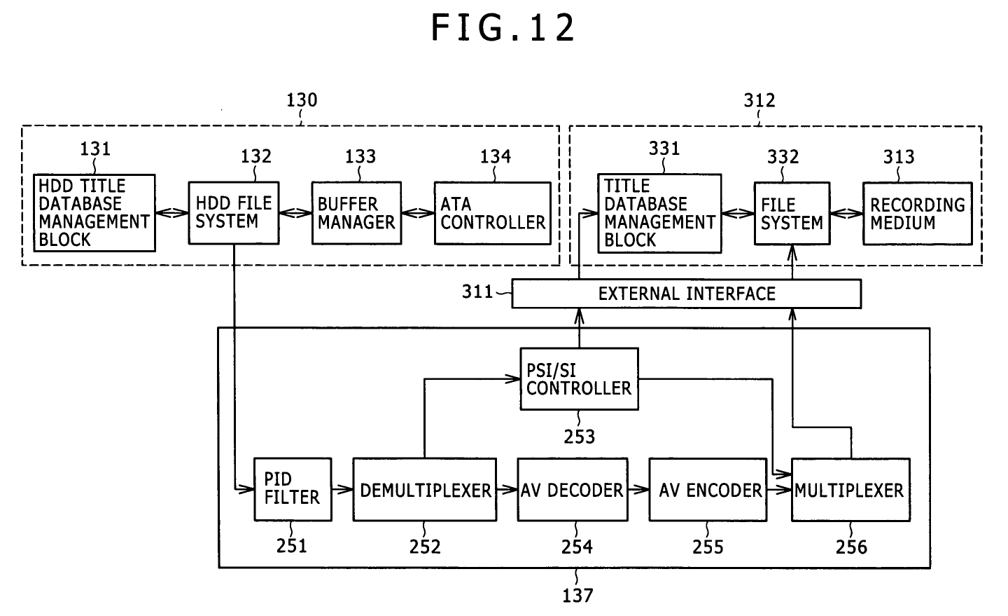

The following describes the dubbing processing in which the dubbing of the content recorded to the HD 112 to the recording medium 313 incorporated in the external device 312 is executed in the re-encode dubbing, with reference to FIG. 12.

FIG. 12 shows an exemplary configuration of the external device 312.

It should be noted that, for the convenience of description of the dubbing processing, the HD recording control unit 130, the CODEC 137, and the external interface 311 of the recording apparatus 302 are shown in addition to the external device 312.

As shown in FIG. 12, the external device 312 has a title database management block 331 and a file system 332 in addition to the recording medium 313.

As with the HDD title database management block 131 (FIG. 11) and the title database management block 139, the title database management block 331 generates a title database for managing the content to be recorded to the recording medium 313.

It should be noted that the information necessary for the title database management block 331 to generate a title database in dubbing content from the HD 112 to the recording medium 313 is supplied from the HD 112 to the title database management block 331 via the HD recording control unit 130 and the CODEC 137.

A title database generated by the title database management block 331 is recorded to the recording medium 313 as occasions demand via the file system 332.

The file system 332 processes the content data and so on supplied from the CODEC 137 such that the content and so on can be handled as a file when recorded to the recording medium 313 and supplies to the recording medium 313.

The file system 332 also supplies the content data and so on reproduced (or read) from the recording medium 313 to a monitor or the like, not shown, for example, of the external device 312 for display as occasions demand.

In dubbing the content recorded to the HD 112 (FIG. 11) to the external device 312 configured as described above, if the CCI of the content subject to dubbing is no-more-copies and the conversion processing for converting the partial TS that is the content data into the MPEG-PS is executed, the partial TS that is the content data subject to dubbing is reproduced from the HD 112 (FIG. 11) to be supplied from the HDD file system 132 of the HD recording control unit 130 to the PID filter 251 of the CODEC 137.

The PID filter 251 extracts, from TS packets making up a partial TS received from the HDD file system 132 of the HD recording control unit 130, a TS packet having PID necessary for converting the partial TS into MPEG-PS and supplies to the demultiplexer 252.

The demultiplexer 252 separates the TS packet of partial packet TS received from the PID filter 251 into image, audio, and control data (of the TS packet). Then, the demultiplexer 252 supplies the AV data of image and audio of the content to the AV decoder 254 and the control data to the PSI/SI controller 253.

As with the PSI/SI controller 125 (FIG. 11), the PSI/SI controller 253 configures the PSI/SI by analyzing the control data received from the demultiplexer 252.

Further, on the basis of a digital copy control descriptor that is the CCI contained in the PSI/SI, the PSI/SI controller 253 recognizes the CCI of the content subject to dubbing and, if the recognized CCI is found to be no-more-copies for example, issues a command for making the CCI of the content subject to dubbing be no-more-copies to the multiplexer 256 and the title database management block 331 of the external device 312 via the external interface 311.

On the other hand, the AV decoder 254 decodes the content data received from the demultiplexer 252. Namely, the content data received from the demultiplexer 252 is encoded by the MPEG algorithm, so that the AV decoder 254 decodes the contented data encoded by the MPEG algorithm.

Next, the AV decoder 254 supplies the decoded baseband content data (AV data) to an AV encoder 255.

As with the AV encoder 128 (FIG. 11), the AV encoder 255 executes appropriate signal processing on the baseband content data received from the AV decoder 254 to encode into the data having a predetermined format and supplies the resultant data to the multiplexer 256.

The multiplexer 256 multiplexes the content data of a predetermined format received from the AV encoder 255 with the CCI and so on specified by the PSI/SI controller 253 to generate MPEG-PS and supplies the resultant MPEG-PS content data to the file system 332 of the external device 312 via the external interface 311.

In the external device 312, the file system 332 records, to the recording medium 313, the MPEG-PS that is the content data to be supplied from the multiplexer 256 of the CODEC 137 via the external interface 311.

Also, in the external device 312, the title database management block 331 generates a title database containing the CCI in accordance with the command from the PSI/SI controller 253 of the CODEC 137 for the content recorded (or dubbed) to the recording medium 313.

The title database generated by the title database management block 331 is recorded to the recording medium 313 via the file system 332, for example.

On the other hand, the dubbing control block 236 (FIG. 11) determines whether the content subject to dubbing recorded to the HD 112 satisfies a copy enable condition that is a predetermined condition, namely, whether the content subject to dubbing is the content that is a program carried by the terrestrial digital broadcasting as described above, for example.

Depending on a decision made in step S74 whether the content subject to dubbing (recorded in HD 112) satisfies the copy enable condition after being recorded to the recording medium 313, the dubbing control block 236 controls the HD recording control unit 130 so as to delete the content subject to dubbing from the HD 112 or leave the content subject to dubbing on the HD 112.

Namely, if the content subject to dubbing is found not satisfying the copy enable condition, if the content subject to dubbing is not a program broadcast by the terrestrial digital broadcasting, or the content subject to dubbing is a program broadcast by the BS digital broadcasting or the CS digital broadcasting, to be more specific, then the dubbing control block 236 controls the HD recording control unit 130 so as to delete the content subject to dubbing from the HD 112.

Under the control of the dubbing control block 236, the HD recording control unit 130 deletes the content subject to dubbing from the HD 112. Therefore, in this case, the content subject to dubbing is moved from the HD 112 to the recording medium 313.

On the other hand, if the content subject to dubbing satisfies the copy enable condition, if the content subject to dubbing is a program broadcast by the terrestrial digital broadcasting for example, to be more specific, then the dubbing control block 236 controls the HD recording control unit 130 so as to leave the content subject to dubbing on the HD 112.

Under the control of the dubbing control block 236, the HD recording control unit 130 leaves the content subject to dubbing on the HD 112 without deleting. Therefore, in this case, the content subject to dubbing is copied from the HD 112 to the recording medium 313.

As described above, in the dubbing of the content that is a program broadcast by the terrestrial digital broadcasting, if the CCI of the content recorded to the HD 112 is no-more-copies, leaving the content on the HD 112 after recording the content from the HD 112 to the recording medium 313 of the external device 312 allows the user to view the content by use of the recording apparatus 302 or by use of the external device 312 carried at an outside location.

Next, the above-mentioned sequence of processing operations executed by the dubbing control block 236 may be executed by software as well as hardware, for example. When the above-mentioned sequence of processing operations is executed by software, the programs constituting the software are installed in a microcomputer that is made function as the dubbing control block 236.

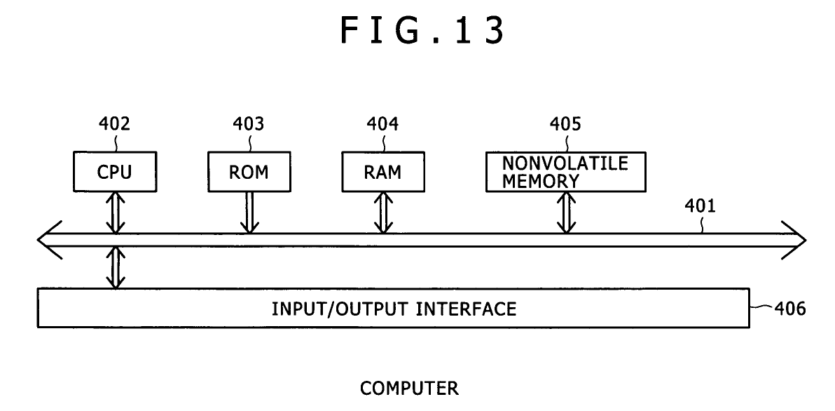

FIG. 13 shows an exemplary configuration of a microcomputer on which programs for executing the above-mentioned sequence of programs are installed.

Each program can be stored in a ROM (Read Only Memory) 403 that is a recording medium incorporated in the microcomputer or a nonvolatile memory 405, such as a flash memory, for example, in advance.

Programs can also be stored (read), temporarily or permanently, in removable recording medium, such as flexible disk, CD-ROM (Compact Disc Read Only Memory), MO (Magneto Optical) disk, DVD (Digital Versatile Disc), a magnetic disk, and semiconductor memory, in advance. These removable recording media can be provided in so-called packaged software.

It should be noted that, in addition to the installation from removable recording media such as mentioned above into a microcomputer, programs may be downloaded from a download site into a microcomputer in a wireless manner via an artificial satellite for the digital satellite broadcasting or via a network such as LAN (Local Area Network) or the Internet in a wired manner. The microcomputer receives downloaded programs to install into the nonvolatile memory 405 incorporated therein.

The microcomputer incorporates a CPU (Central Processing Unit) 402. The CPU 402 is connected with the ROM 403, a RAM (Random Access Memory) 404, the nonvolatile memory 405, and an input/output interface 406 via a bus 401. The CPU 402 loads, into the RAM 404, programs stored in the ROM 403 or the nonvolatile memory 405 or downloaded via a satellite or a network and installed in the nonvolatile memory 405 or installed into the nonvolatile memory 405 after being read from a removable recording medium not shown. Consequently, the CPU 402 executes the processing in a sequence shown by the flowcharts of FIG. 9 and so on as instructed by these programs, thereby controlling each component block of the recording apparatus 202 or the recording apparatus 302, not shown in FIG. 13, via the input/output interface 406.

It should be noted herein that the steps for describing each program recorded in a recording medium for directing the microcomputer (or the CPU 402) to execute the processing include not only the processing operations which are sequentially executed in a time-dependent manner but also the processing operations which are executed concurrently or discretely (parallel processing or object-oriented processing, for example).

It should also be noted that each program may be executed by one CPU or by a plurality of CPUs in a distributed manner.

In the above-mentioned embodiments of the invention, content is either deleted from the HD 112 or left on the HD 112 depending on whether the content is a program broadcast by the terrestrial digital broadcasting. It is also practicable to determine whether to delete or leave content from or on the HD 112 on the basis of various kinds of information recognizable from the PSI/SI contained in each RF signal from the transmission apparatus 101, such as content broadcasting channel information, content account information, and content broadcasting form information indicative of terrestrial digital, BS digital, CS digital, or IPTV (Internet Protocol Television), for example, or on the basis of a dedicated identification flag newly contained in PSI/SI in each broadcasting station that broadcasts contents. This dedicated flag may be indicative whether content is charged or free of charge or control information commanding whether to especially leave content on the HD 112, for example. If any of these broadcasting form information and dedicated identification flag is used, these information and flag can be recognized from PSI/SI and, like the broadcasting form identification information of the embodiments of the invention, related with each corresponding piece of content to be recorded (or held) in a corresponding title database, thereby allowing the determination whether to delete each piece of content from the HD 112 or leave each piece of content on the HD 112.

If a part of content is broadcast by the terrestrial digital broadcasting and the remaining part by the BS digital broadcasting or the CS digital broadcasting, the entire piece of content can be handled a program broadcast by the BS digital broadcasting or the CS digital broadcasting, thereby deleting the entire piece of content from the HD 112 in a dubbing operation. Alternatively, in a dubbing operation, it is practicable to leave the part of content broadcast by the terrestrial digital broadcasting without deletion from the HD 112, while deleting the part broadcast by the BS digital broadcasting or the CS digital broadcasting from the HD 112.

While preferred embodiments of the present invention have been described using specific terms, such description is for illustrative purpose only, and it is to be understood that changes and variations may be made without departing from the spirit or scope of the following claims.

1. A recording apparatus for recording content to a content recording medium, comprising:
dubbing means for recording content recorded to said content recording medium to another content recording medium for dubbing;
determining means for determining whether content recorded to said content recording medium satisfies a predetermined condition; and
controlling means for recording, if content with copy control information thereof set to no-more-copies indicative of copy prohibition is found not satisfying said predetermined condition, said content from said content recording medium to said another content recording medium and then deleting said content from said content recording medium, and
if said content with said copy control information thereof set to no-more-copies is found satisfying said predetermined condition, recording said content from said content recording medium to said another content recording medium and leaving said content on said content recording medium.

2. The recording apparatus according to claim 1, wherein said recording apparatus holds identification information indicative of a transmission path along which said content has been transmitted in correspondence with said content and
said determining means determines on the basis of said identification information whether said content satisfies said predetermined condition in accordance with said transmission path.

3. The recording apparatus according to claim 1, wherein said recording apparatus holds account information associated with said content in correspondence with said content and
said determining means determines on the basis of said account information whether said content satisfies said predetermined condition.

4. The recording apparatus according to claim 1, wherein said recording apparatus holds identification information different from said copy control information, said identification information being indicative whether said content satisfies said predetermined condition, and
said determining means determines on the basis of said identification information whether said content satisfies said predetermined condition.

5. The recording apparatus according to claim 2, wherein, with said predetermined condition being broadcast by terrestrial digital broadcasting, said determining means determines whether said content recorded to said content recording medium is content broadcast by terrestrial digital broadcasting.

6. The recording apparatus according to claim 1, wherein said content recording medium is a recording medium incorporated in said recording apparatus and
said another content recording medium is one of recording medium that are detachably loaded on said recording apparatus and recorded and reproduced by an external device.

7. The recording apparatus according to claim 1, further comprising:
recording specifying means for obtaining, of AV (Audio Visual) data and control data, said copy control information of content from said control data and, if said copy control information is set to copy-once indicative of a permission of copy of one time, setting copy control information to no-more-copies, thereby specifying recording of content to said content recording medium; and
title database generating means for generating a title database for managing content recorded to said content recording medium as specified by said recording specifying means, said title database containing at least said copy control information,
wherein said controlling means, if content with said copy control information set to no-more-copies contained in said title database is found not satisfying said predetermined condition, records said content from said content recording medium to said another content recording medium and then deletes said content from said content recording medium, and
if content with said copy control information contained in said title database set to no-more-copies is found satisfying said predetermined condition, records said content from said content recording medium to said another content recording medium and leaves said content on said content recording medium.

8. A control method for controlling a recording apparatus for recording content to a content recording medium, comprising:
recording content recorded to said content recording medium to another content recording medium for dubbing;
determining whether content recorded to said content recording medium satisfies a predetermined condition; and
executing control for recording, if content with copy control information thereof set to no-more-copies indicative of copy prohibition is found not satisfying said predetermined condition, said content from said content recording medium to said another content recording medium and then deleting said content from said content recording medium, and
if said content with said copy control information thereof set to no-more-copies is found satisfying said predetermined condition, recording said content from said content recording medium to said another content recording medium and leaving said content on said content recording medium.

9. A program for making a computer for controlling a recording apparatus for recording content to a content recording medium execute:
recording content recorded to said content recording medium to another content recording medium for dubbing;
determining whether content recorded to said content recording medium satisfies a predetermined condition; and
executing control for recording, if content with copy control information thereof set to no-more-copies indicative of copy prohibition is found not satisfying said predetermined condition, said content from said content recording medium to said another content recording medium and then deleting said content from said content recording medium and,
if said content with said copy control information thereof set to no-more-copies is found satisfying said predetermined condition, recording said content from said content recording medium to said another content recording medium and leaving said content on said content recording medium.

10. A recording apparatus for recording content to a content recording medium, comprising:
a dubbing section configured to record content recorded to said content recording medium to another content recording medium for dubbing;
a determining section configured to determine whether content recorded to said content recording medium satisfies a predetermined condition; and
a controlling section configured to, if content with copy control information thereof set to no-more-copies indicative of copy prohibition is found not satisfying said predetermined condition, record said content from said content recording medium to said another content recording medium and then delete said content from said content recording medium and,
if said content with said copy control information thereof set to no-more-copies is found satisfying said predetermined condition, record said content from said content recording medium to said another content recording medium and leave said content on said content recording medium.
